(19) United States
(12) Patent Application Publication
(10) Pub. No.: US 2007/0179765 A1
(43) Pub. Date: Aug. 2, 2007

(54) Method for solving transient solution and dynamics in film blowing process

(76) Inventors: Jae-Chun Hyun, Seoul (KR); Hyun-Wook Jung, Seoul (KR); Hyun-Seob Song, Daejeon (KR); Hyun-Chul Kim, Goyang-si (KR); Joo-Sung Lee, Seonganam-si (KR); Dong-Myeong Shin, Goyang-si (KR)

Correspondence Address: BIRCH STEWART KOLASCH & BIRCH, PO BOX 747, FALLS CHURCH, VA, 22040-0747, US

(21) Appl. No.: 10/590,113

(22) PCT Filed: Feb. 18, 2005
(86) PCT No.: PCT/KR05/00431

§ 371 Date: Aug. 18, 2006

(30) Foreign Application Priority Data
Feb. 16, 2005 (KR) 10 2005-0012890

(51) Int. Cl. G06G 7/48

(52) U.S. Cl. 703/9

(57) ABSTRACT

The present invention concerns the dynamics and yielding of transient solutions for the film-blowing process. After solving the governing equations that takes into consideration the viscoelasticity and cooling characteristics of the film, a coordinate transformation was done to change the free-end-point problem into a fixed-end-point one. Then finally, by introducing Newton's method along with OCFE (Orthogonal Collocation on Finite Elements), a transient solution for the process was obtained.

### TECHNICAL FIELD

The present invention concerns a dynamic scheme for the film-blowing process and a method for solving transient solutions for the process. More specifically, the present invention solves the governing equations that take into consideration the viscoelasticity and cooling characteristics of film, and then through coordinate transformation, the invention transforms a free-end-point problem into a fixed-end-point problem. Then, by introducing Newton's method along with the OCFE (Orthogonal Collocation on Finite Elements) method, a new method for solving transient solutions is formulated.

### BACKGROUND ART

The film-blowing process is a typical bi-axial extensional deformation process that produces oriented film by stretching and cooling polymer melts continuously extruded from an annular die in both axial and circumferential directions simultaneously, as shown in FIG. 1. The axial extension is imposed by the drawing force of the nip rolls whereas the circumferential extension is imposed by the air pressure inside the bubble. This film-blowing is similar to fiber spinning and film casting in engendering the extensional deformation of the material, yet salient in causing a biaxial extension. By manipulating the two important parameters of the system, i.e., the drawdown ratio (the ratio of the film velocities at the die exit and nip rolls) and the blowup ratio of the bubble between the die exit and the maximum bubble radius point, the process can be controlled as desired with respect to the process and the film product.

Over the past four decades, many theoretical and experimental studies have been conducted on this important process. Among the major research results, the most comprehensive stability analysis was first carried out by Cain and Denn [Polym. Eng. Sci. 28: 1527, 1988] and then followed by Yoon and Park [Int. Polym. Proc. 14: 342, 1999]. Along with many interesting stability findings, the draw resonance instability, a self-sustained limit cycle-type supercritical Hopf bifurcation, has been well documented in these studies.

While the basic understanding of the process in terms of steady state operations and linear stability has been greatly advanced by all these efforts, there still remains the need for a transient solution for the process to reveal its nonlinear dynamics and nonlinear stability, which are acutely warranted for devising any systematic strategies for process stabilization and optimization. Unlike steady-state solutions that are relatively easy to obtain, the transient solutions of the governing equations of the process have long eluded theoretical pursuit, mainly due to the complex nonlinear nature of the partial differential equations and the boundary conditions.

Due to the characteristics of a non-Newtonian fluid in terms of complex structure and difficulty in being interpreted, which is used as a subject for the rheologically-governed process, there is a variety in flow characteristics and instability. In particular, the representative instability, a draw resonance phenomenon that takes place during the extension deformation process, impedes the productivity of the process. Therefore, the process should be interpreted from a dynamic perspective, and control and design technology based on the nonlinear theory needs to be urgently developed more than anything else in order to overcome the instability and improve the productivity of the Theological process. Despite the significance of the film blowing process in industrial use, which produces films with wider width through the biaxial extension caused by the velocity difference and the pressure difference, among all the extension deformation processes, the results of a transient solution for the process have not yet been reported due to the highly complicated nonlinearity of the governing equation, in comparison with the other processes. So far, neither nonlinear stability analysis nor a transient solution for the non-isothermal governing equations, which explain the cooling of the film-blowing process, have been reported anywhere in the world.

The inventors employed the Phan Thien-Tanner (PTT) constitutive model, known for its capability to accurately portray the extensional flows of viscoelastic polymers, and an energy equation where the cooling characteristics of the film is taken into account for the system, thereby enabling them to formulate a transient solution for the non-isothermal film-blowing process and analyze the stability of the nonlinear system.

### DISCLOSURE OF THE INVENTION

### Technical Problems

The purpose of the present invention is to solve the governing equations in the form of partial differential equations for the film-blowing process with its viscoelasticity and cooling characteristics in mind. Then, through coordinate transformation, we transformed the free-end-point problem into a fixed-end-point problem, and finally, by using numerical schemes such as Newton's method and OCFE (Orthogonal Collocation on Finite Elements), we provide a new method for yielding transient solutions.

### Technical Solutions

The above mentioned objective of the invention is to yield a governing equation for the film-blowing process, in which viscoelasticity and cooling are considered, and effectively simulate the real process by effectively formulating a transient solution through methods such as Newton's method or the OCFE. It is expected that the results drawn from the calculation can be applied in developing a device for the optimization and stabilization of the film blowing process, establishing optimal operating conditions, and developing a polymer material.

The present invention is characterized by four stages. The first stage is the solving of governing equations. The next stage is the yielding of transient solutions through the use of coordinate transformation and numerical methods such as Newton's method and OCFE. The third stage is the comparison stage wherein the results from the calculations are compared with the actual results from the experiments of the process. In the final stage, strategies for the optimization and stabilization of the process are drawn up.

The present invention solves the governing equations in the manner shown below. Then, the coordinates are transformed along the temperature-time axis and then, by using Newton's method and the OCFE (Orthogonal Collocation on Finite Element) method, we provide the method for solving transient solutions for the non-isothermal film-blowing process:
Equation:

$$\frac{\partial }{\partial t} ( rw \sqrt{1 + {( \frac{\partial r}{\partial z} )}^{2}} ) + \frac{\partial }{\partial z} ( rwv ) = 0 \\ Here , \\ t = \frac{\overline{t} \overline{{v}_{0}}}{\overline{{r}_{0}}} , z = \frac{\overline{z}}{\overline{{r}_{0}}} , r = \frac{\overline{r}}{\overline{{r}_{0}}} , v = \frac{\overline{v}}{\overline{{v}_{0}}} , w = \frac{\overline{w}}{\overline{{w}_{0}}} \qquad ( 1 )$$

Axial Ddirection:

$$\frac{2 rw [ ( {τ}_{11} - {τ}_{22} ) ] + 2 r {σ}_{surf}}{\sqrt{1 + {( \partial r / \partial z )}^{2}}} + B ( {r}_{F}^{2} - {r}^{2} ) - 2 {C}_{gr} {\int }_{0}^{{z}_{L}} r ω \sqrt{1 + {( \frac{\partial r}{\partial z} )}^{2}} ⅆ z - 2 {\int }_{0}^{{z}_{L}} {rT}_{drag} ⅆ z = {T}_{z} \\ Here , \\ {T}_{z} = \frac{{\overline{T}}_{z}}{2 π {η}_{0} \overline{{w}_{0}} \overline{{v}_{0}}} , B = \frac{\overline{{r}_{0}^{2}} Δ P}{2 {η}_{0} \overline{{w}_{0}} \overline{{v}_{0}}} , Δ P = \frac{A}{{\int }_{0}^{\overline{{z}_{L}}} π \overline{{r}^{2}} ⅆ \overline{z}} - {P}_{a} , {τ}_{ij} = \frac{\overline{{τ}_{ij}} \overline{{r}_{0}}}{2 {η}_{0} {v}_{0}} \\ {C}_{g r} = \frac{ρ g \overline{{r}_{0}^{2}}}{2 {η}_{0} {v}_{0}} , {T}_{drag} = \frac{\overline{{T}_{drag}} \overline{{r}_{0}^{2}}}{2 {η}_{0} \overline{{v}_{0}} \overline{{w}_{0}}} , {σ}_{surf} = \frac{\overline{{σ}_{surf}} \overline{{r}_{0}}}{2 {η}_{0} \overline{{v}_{0}} \overline{{w}_{0}}} \qquad ( 2 )$$

Circumferential Direction:

$$B = ( \begin{matrix}\frac{[ - w ( {τ}_{11} - {τ}_{22} ) + 2 {σ}_{surf} ] ( \frac{{\partial }^{2} r}{\partial {z}^{2}} )}{{[ 1 + {( \frac{\partial r}{\partial z} )}^{2} ]}^{3 / 2}} + \frac{w ( {τ}_{33} - {τ}_{22} ) + 2 {σ}_{surf}}{r \sqrt{1 + {( \frac{\partial r}{\partial z} )}^{2}}} - \\ {C}_{ g r} \frac{ \frac{\partial r}{\partial z}}{ \sqrt{1 + {( \frac{\partial r}{\partial z} )}^{2}}}\end{matrix} ) \qquad ( 3 )$$

Constitutive Equation:

$$K τ + De [ \frac{\partial τ}{\partial t} + v \cdot ∇ τ - L \cdot τ - τ \cdot {L}^{T} ] = 2 \frac{De}{{De}_{0}} D \\ Here , \\ K = exp [ ε De tr τ ] , L = ∇ v - ξ D , 2 D = ( ∇ v + ∇ {v}^{T} ) , {De}_{0} = \frac{λ \overline{{v}_{0}}}{\overline{{τ}_{0}}} , \\ De = {De}_{0} exp [ k ( \frac{1}{θ} - 1 ) ] \qquad ( 4 )$$

Energy Equation:

$$\frac{\partial θ}{\partial t} + \frac{1}{\sqrt{1 + {( \frac{\partial r}{\partial z} )}^{2}}} \frac{\partial θ}{\partial z} + \frac{U}{w} ( θ - {θ}_{c} ) + \frac{E}{w} ( {θ}^{4} - {θ}_{∞}^{4} ) = 0 \\ Here , \\ θ = \frac{\overline{θ}}{{θ}_{0}} , {θ}_{c} = \frac{\overline{{θ}_{c}}}{{θ}_{0}} , {θ}_{∞} = \frac{\overline{{θ}_{∞}}}{{θ}_{0}} , U = \frac{\overline{U} \overline{{r}_{0}}}{ρ {C}_{p} \overline{{w}_{0}} \overline{{v}_{0}}} , \\ \overline{U} = α ( \frac{{k}_{air}}{\overline{z}} ) {( \frac{{ρ}_{air} \overline{{v}_{c}} \overline{z}}{{η}_{air}} )}^{β} , E = \frac{{ε}_{m} {σ}_{SB} \overline{{θ}_{0}^{4}} \overline{{r}_{0}}}{ρ {C}_{p} \overline{{w}_{0}} \overline{{v}_{0}} {θ}_{0}} \qquad ( 5 )$$

Boundary Conditions:

$$\begin{matrix}v = w = r = θ = 1 , τ = {τ}_{0} & at z = 0 \\ \frac{\partial r}{\partial t} + \frac{\partial r}{\partial z} \frac{v}{\sqrt{1 + {( \frac{\partial r}{\partial z} )}^{2}}} = 0 , \frac{v}{ \sqrt{1 + {( \frac{\partial r}{\partial z} )}^{2}}} = {D}_{R} θ = {θ}_{F} & at z = {z}_{F}\end{matrix} \qquad \begin{matrix}( 6 a ) \\ \\ ( 6 b )\end{matrix}$$

In the above equations, r denotes the dimensionless bubble radius, w the dimensionless film thickness, v the dimensionless fluid velocity, t the dimensionless time, z the dimensionless distance coordinate, ΔP the air pressure difference between inside and outside the bubble, B the dimensionless pressure drop, A the air amount inside the bubble, Pₐ the atmospheric pressure, T_{z} the dimensionless axial tension, C_{gr} the gravity coefficient, T_{drag} the aerodynamic drag, σ_{surf} the surface tension, θ the dimensionless film temperature, τ the dimensionless stress tensor, D the dimensionless train rate tensor, ε and ξ the PTT model parameters, De the Deborah number, θ₀ the zero-shear viscosity, K the dimensionless activation energy, U the dimensionless heat transfer coefficient, E the dimensionless radiation coefficient, kₐᵢᵣ the thermal conductivity of cooling air, ρₐᵢᵣ the density of cooling air, ηₐᵢᵣ the viscosity of cooling air, v_{c} dimensionless cooling air velocity, α and β parameters of heat transfer coefficient relation, θ_{c} the dimensionless cooling-air temperature, θ_{∞} the dimensionless ambient temperature, εₘ the emissivity, σ_{SB} the Stefan-Boltzmamn constant, ρ the density, Cₚ the heat capacity, and D_{R} the drawdown ratio.

However, the assumption was made that no deformation occurred in the film past the freezeline at the boundary conditions. Overbars denote the dimensional variables. Subscripts 0, F and L denote the die exit, the freezeline conditions and the nip roll conditions, respectively. Subscripts 1, 2 and 3 denote the flow direction, normal direction and circumferential direction, respectively.

In the present invention, while in the process of yielding numerical solutions for the isothermal film-blowing process, we employed a coordinate transformation to make time and temperature as new independent variables in lieu of the original time and distance. Through this transformation, the moving freezeline height can be handled effectively because the boundary conditions are clearly set. Also, in the numerical analysis methods, the Newton's method and OCFE were employed.

In the non-isothermal process model used for the present invention, a total of three multiplicities were discovered, and this matches the experimental results. In addition, after analysis of the three points of stabilization where multiplicities exist, we discovered that at points in the bubble with the smallest and the largest radius, the disturbances introduced into the system disappear after some time. However, at points in the middle, the disturbances increase and draw resonance occurs. This also matches the experimental results. Especially in the case of draw resonance, the transient solutions for the amplitude and period of the bubble radius can be exactly predicted.

Hereafter, practical examples will be used to explain in more detail the specific methods of the present invention. However, the applications of the present invention are not limited to only these examples.

### BRIEF DESCRIPTION OF THE DRAWINGS

FIG. 1 shows the film-blowing process.

FIG. 2 is a graph that shows the optimum number for each factor along with the optimum number for the collocation point by making use of the transient response indications. Inaccurate results: NE=4, NP=5(-.-); NE=5, NP=4(-..-); Accurate results: NE=5, NP=5(-); NE=5, NP=6(--); NE=6, NP=5( . . . ). (a) shows the case during small time, (b) during large time, and (c) when NE=5 and when NP=5.

FIG. 3 represents the typical variations of the bubble radius and the freezeline height along the flow direction during one period of the draw resonance oscillation, when the sustained periodicity of the draw resonance is fully developed.

Under the same condition of FIG. 3, FIG. 4 shows the dimensionless bubble radius changes during one period of oscillations plotted (a) against the dimensionless distance from the die exit to the freezeline, z, and (b) against the transformed temperature coordinate (zeta).

FIG. 5 shows the multiplicities of the non-isothermal process obtained by observing the intersections of the straight line of a constant drawdown ratio (D_{R}=35) and the curve of a constant air pressure (B=0.37). (a) shows the simulations results, (b) shows the stability at point H, (c) shows the numerical scheme results at point H along with the draw resonance that appeared during the experiment, and finally (d) shows the stabilization at point L.

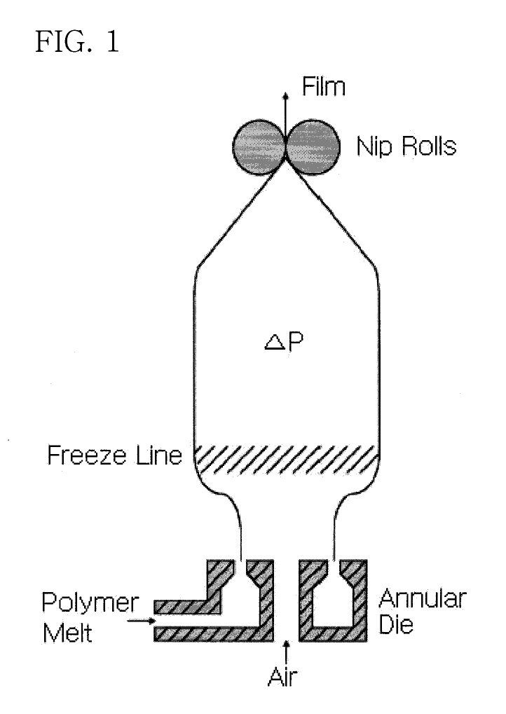

### BEST MODE

### EXAMPLE 1

### Solution for the Governing Equations of the Film-Blowing Process and Yielding of Transient Solutions by Using Numerical Methods

Trying to solve the new governing equations while considering the non-isothermal characteristics of the film-blowing process and then yielding transient solutions by using several numerical analysis methods is vital in the theoretical study concerning the stabilization of the process.

The dimensionless governing equations of the non-isothermal film-blowing of PTT fluids, based on the seminal work of Pearson and Petrie (J. Fluid Mech. 40(1970) 1 and 42(1970) 609), who established the first modeling equations and the standard for all ensuring research efforts, are as follows:
Equations:

$$\frac{\partial }{\partial t} ( rw \sqrt{1 + {( \frac{\partial r}{\partial z} )}^{2}} ) + \frac{\partial }{\partial z} ( rwv ) = 0 \\ Here , \\ t = \frac{\overline{t} \overline{{v}_{0}}}{\overline{{r}_{0}}} , z = \frac{\overline{z}}{\overline{{r}_{0}}} , r = \frac{\overline{r}}{\overline{{r}_{0}}} , v = \frac{\overline{v}}{\overline{{v}_{0}}} , w = \frac{\overline{w}}{\overline{{w}_{0}}} \qquad ( 1 )$$

Axial Direction:

$$\frac{2 rw [ ( {τ}_{11} - {τ}_{22} ) ] + 2 r {σ}_{surf}}{\sqrt{1 + {( \partial r / \partial z )}^{2}}} + B ( {r}_{F}^{2} - {r}^{2} ) - 2 {C}_{gr} {\int }_{0}^{{z}_{L}} r ω \sqrt{1 + {( \frac{\partial r}{\partial z} )}^{2}} ⅆ z - 2 {\int }_{0}^{{z}_{L}} {rT}_{drag} ⅆ z = {T}_{z} \\ Here , \\ {T}_{z} = \frac{{\overline{T}}_{z}}{2 π {η}_{0} \overline{{w}_{0}} \overline{{v}_{0}}} , B = \frac{\overline{{r}_{0}^{2}} Δ P}{2 {η}_{0} \overline{{w}_{0}} \overline{{v}_{0}}} , Δ P = \frac{A}{{\int }_{0}^{\overline{{z}_{L}}} π \overline{{r}^{2}} ⅆ \overline{z}} - {P}_{a} , {τ}_{ij} = \frac{\overline{{τ}_{ij}} \overline{{r}_{0}}}{2 {η}_{0} {v}_{0}} \\ {C}_{g r} = \frac{ρ g \overline{{r}_{0}^{2}}}{2 {η}_{0} {v}_{0}} , {T}_{drag} = \frac{\overline{{T}_{drag}} \overline{{r}_{0}^{2}}}{2 {η}_{0} \overline{{v}_{0}} \overline{{w}_{0}}} , {σ}_{surf} = \frac{\overline{{σ}_{surf}} \overline{{r}_{0}}}{2 {η}_{0} \overline{{v}_{0}} \overline{{w}_{0}}} \qquad ( 2 )$$

Circumferential Direction:

$$B = ( \begin{matrix}\frac{[ - w ( {τ}_{11} - {τ}_{22} ) + 2 {σ}_{surf} ] ( \frac{{\partial }^{2} r}{\partial {z}^{2}} )}{{[ 1 + {( \frac{\partial r}{\partial z} )}^{2} ]}^{3 / 2}} + \frac{w ( {τ}_{33} - {τ}_{22} ) + 2 {σ}_{surf}}{r \sqrt{1 + {( \frac{\partial r}{\partial z} )}^{2}}} - \\ {C}_{ g r} \frac{ \frac{\partial r}{\partial z}}{ \sqrt{1 + {( \frac{\partial r}{\partial z} )}^{2}}}\end{matrix} ) \qquad ( 3 )$$

Constitutive Equation:

$$K τ + De [ \frac{\partial τ}{\partial t} + v \cdot ∇ τ - L \cdot τ - τ \cdot {L}^{T} ] = 2 \frac{De}{{De}_{0}} D \\ Here , \\ K = exp [ ε De tr τ ] , L = ∇ v - ξ D , 2 D = ( ∇ v + ∇ {v}^{T} ) , {De}_{0} = \frac{λ \overline{{v}_{0}}}{\overline{{τ}_{0}}} , \\ De = {De}_{0} exp [ k ( \frac{1}{θ} - 1 ) ] \qquad ( 4 )$$

Energy Equation:

$$\frac{\partial θ}{\partial t} + \frac{1}{\sqrt{1 + {( \partial r / \partial z )}^{2}}} \frac{\partial θ}{\partial z} + \frac{U}{w} ( θ - {θ}_{c} ) + \frac{E}{w} ( {θ}^{4} - {θ}_{∞}^{4} ) = 0 \\ Here , \\ θ = \frac{\overline{θ}}{{θ}_{0}} , {θ}_{c} = \frac{{\overline{θ}}_{c}}{{θ}_{0}} , {θ}_{∞} = \frac{{\overline{θ}}_{∞}}{{θ}_{0}} , U = \frac{\overline{{Ur}_{0}}}{p {C}_{p} \overline{{w}_{0 }} \overline{{v}_{0}}} , \overline{U} = α ( \frac{{k}_{air}}{\overline{z}} ) {( \frac{{ρ}_{air} \overline{{v}_{0}} , \overline{z}}{{η}_{air}} )}^{β} , E = \frac{{ε}_{m} {σ}_{SB} \overline{{θ}_{0}^{4}} \overline{{r}_{0}}}{ρ {C}_{p} \overline{{w}_{0 }} \overline{{v}_{0}} {θ}_{0}} \qquad ( 5 )$$

Boundary Conditions:

$$\begin{matrix}v = w = r = θ = 1 , \begin{matrix}τ = {τ}_{0} & at z = 0\end{matrix} & ( 6 a ) \\ \begin{matrix}\begin{matrix}\frac{\partial r}{\partial t} + \frac{\partial r}{\partial z} \frac{v}{\sqrt{1 + {( \partial r / \partial z )}^{2}}} = 0 , \\ \frac{v}{\sqrt{1 + {( \partial r / \partial z )}^{2}}} = {D}_{R} , θ = {θ}_{F}\end{matrix} & at z = {z}_{F}\end{matrix} & ( 6 b )\end{matrix}$$

In the above equations, r denotes the dimensionless bubble radius, w the dimensionless film thickness, v the dimensionless fluid velocity, t the dimensionless time, z the dimensionless distance coordinate, ΔP the air pressure difference between inside and outside the bubble, B the dimensionless pressure drop, A the air amount inside the bubble, Pₐ the atmospheric pressure, T_{z} the dimensionless axial tension, C_{gr} the gravity coefficient, T_{drag} the aerodynamic drag, σ_{surf} the surface tension, θ the dimensionless film temperature, τ the dimensionless stress tensor, D the dimensionless train rate tensor, ε and ξ the PTT model parameters, De the Deborah number, θ₀ the zero-shear viscosity, K the dimensionless activation energy, U the dimensionless heat transfer coefficient, E the dimensionless radiation coefficient, kₐᵢᵣ the thermal conductivity of cooling air, ρₐᵢᵣ the density of cooling air, ηₐᵢᵣ the viscosity of cooling air, v_{c} dimensionless cooling air velocity, α and β parameters of heat transfer coefficient relation, θ_{c} the dimensionless cooling-air temperature, θ₂₈ the dimensionless ambient temperature, εₘ the emissivity, σ_{SB} the Stefan-Boltzmamn constant, ρ the density, Cₚ the heat capacity, and D_{R} the drawdown ratio.

However, the assumption was made that no deformation occurred in the film past the freezeline at the boundary conditions. Overbars denote the dimensional variables. Subscripts 0, F and L denote the die exit, the freezeline conditions and the nip roll conditions, respectively. Subscripts 1, 2 and 3 denote the flow direction, normal direction and circumferential direction, respectively.

Several assumptions have been incorporated in the above model:

First, the thin film approximation that all state variables depend on the time and z-coordinate, simplifies the system into a one-dimensional model.

Second, the bubble is axisymmetric, excluding possible helical instability.

Third, the secondary forces acting on the film, such as inertia, gravity, air-drag and surface tension are neglected.

Fourth, the crystallization kinetics of polymer melts are not included here.

Finally, the origin of the z-coordinate is chosen at the point of extrudate swell, meaning the deformation of polymer melts inside the die being lumped into the initial conditions at z=0.

It has proven to be impossible to yield transient solutions in the above governing equations for the non-isothermal film-blowing process using conventional numerical schemes. Especially in cases where draw resonance instability exists in the process, a new and effective numerical scheme has to be devised in order to yield transient solutions.

First, we tried a finite difference method (FDM) of successive iterations that involves solving each equation for one variable while the other state variables are assumed as known. Although this method has been successful in fiber spinning and film casting, it failed for the present invention mainly because of the existence of a nonlinear term in the equations (i.e. \sqrt{1+(∂r/∂z)²}) which stems from the fact that the fluid velocity is in the film direction, not in the machine direction.

Next, we applied the Newton's method with FDM to simultaneously solve the equations for all dependent variables. However, this method entails an extremely long computation time in the order of weeks, if computations are ever possible, due to the full matrix calculations, thus rendering itself unworkable for all practical purposes.

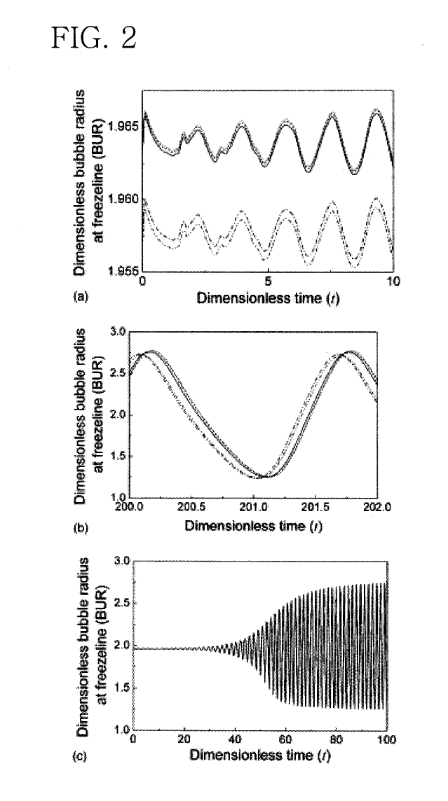

Finally, we introduced an orthogonal collocation method on the finite elements of z-coordinate (OCFE). Employing a minimum number of finite elements (NE) and a minimum number of collocation points (NP) within each element to guarantee accurate transient solutions with manageable computation times, both of which turned out to be five in the present invention (FIGS. 2a and 2b), we finally succeeded in devising a numerical scheme for generating transient solutions for the process even during the instability of draw resonance. Analytically-derived expressions for each element in the Jacobian matrix further facilitate the solution procedure with much ease. For the transient simulation, an implicit second-order backward scheme in time-derivative terms was used to enhance numerical robustness. FIG. 2c shows a typical example of the time convergence of a transient solution in draw resonance.

With the OCFE, we also introduced several important modeling ideas for a more accurate description of the system. First, to handle the moving freezeline height, a coordinate transformation was employed to make time and temperature as new independent variables in lieu of the original time and distance. This transformation essentially converted the free-end-point problem into a computationally amenable fixed-end-point one. The following coordinate transformation was applied:

$$ζ = \frac{{θ}_{0} - θ}{{θ}_{0} - {θ}_{F}} \qquad ( 7 )$$

Here, the new independent variable ζ becomes 0 at the die exit and 1 at freezeline height. By applying the above transformation to the governing equations, a new (t, ζ) coordinate replaces the (t, z) coordinate:

$$\begin{matrix}{( \frac{\partial f}{\partial z} )}_{t} = {( \frac{\partial f}{\partial ζ} )}_{t} {( \frac{\partial z}{\partial ζ} )}_{t}^{- 1} & ( 8 ) \\ {( \frac{\partial f}{\partial t} )}_{z} = {( \frac{\partial f}{\partial t} )}_{ζ} - {( \frac{\partial f}{\partial ζ} )}_{t} {( \frac{\partial z}{\partial ζ} )}_{t}^{- 1} {( \frac{\partial z}{\partial t} )}_{ζ} & ( 9 )\end{matrix}$$

Here, f represents all state variables.

Second, instead of the so-called cylindrical approximation in calculating the amount of air pressure inside the bubble as used by others, in the present invention, the actual shape of the bubble is traced when calculating the real bubble volume. This allows the exact temporal shape of the propagating bubble disturbances to be captured in the simulation during the oscillating instability.

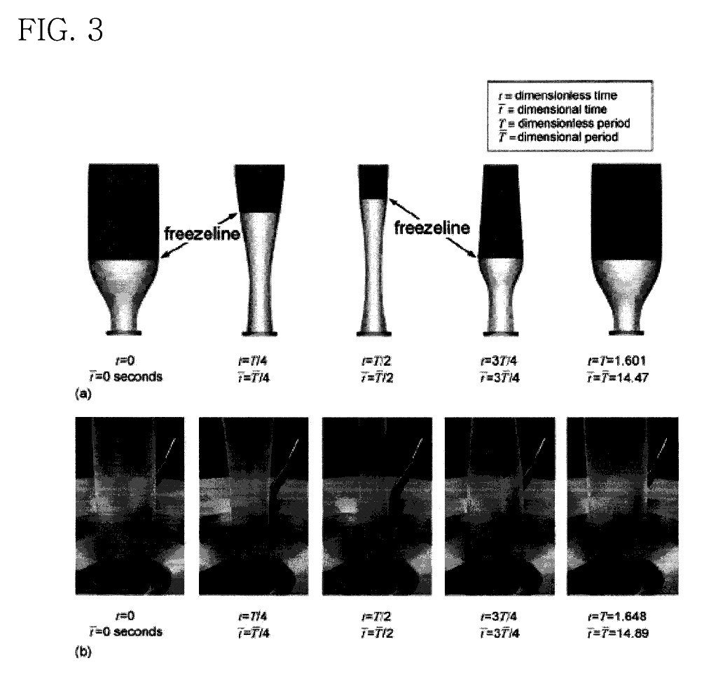

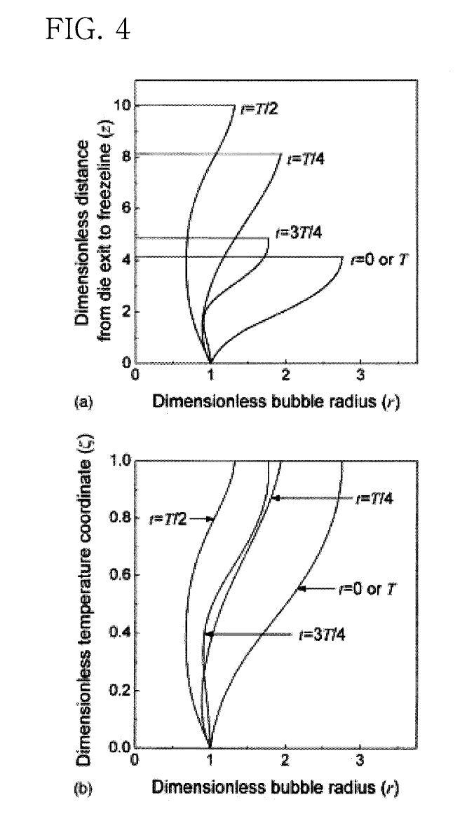

FIG. 3 shows the comparison of simulation data in draw resonance with a real experimental case. To our knowledge, this demonstration of transient behavior is the first in the literature. In view of the assumptions incorporated in the modeling of the highly nonlinear dynamical process of film-blowing, the closeness of the simulation results to real observations is considered as a modeling and numerical breakthrough. To clearly depict the transient behavior of the state variables in this draw resonance, the dimensionless bubble radius during one period of the oscillation is plotted in FIG. 4a against the dimensionless distance from the die exit to the freezeline height, i.e., the original independent variable (z), and also plotted in FIG. 4b against the transformed dimensionless temperature coordinate (ζ), i.e., the new independent variable, which always has the same unity value at the freezeline point.

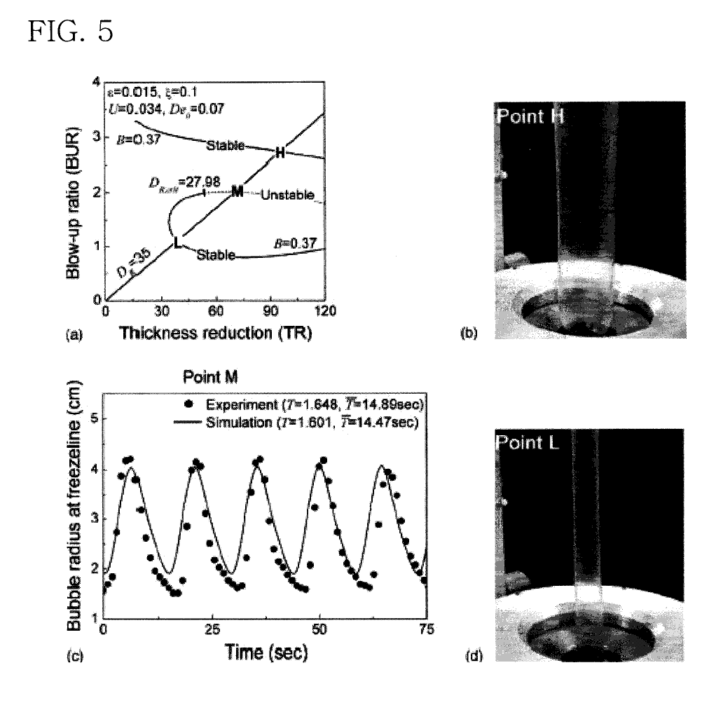

FIG. 5 exhibits an interesting case where three experimentally observed steady states were simulated quite closely, attesting to the usefulness and robustness of the simulation model. The three steady states in these particular cases were determined in the stability diagram by the intersections of the straight line of a constant drawdown ratio (which has a fixed slope of 1/35 because the drawdown ratio (DR=35 here) is, by definition, equal to the ratio of the thickness reduction (TR) and the blowup ratio of the bubble (BUR)) and the curves of a constant air pressure inside the bubble (B=0.37 here). The stability diagram in FIG. 5a was obtained using linear stability analysis. Among these three steady states, only the middle one (FIG. 5c) turns out to be unstable, exhibiting draw resonance, whereas the other two steady states, the upper and lower BUR steady states (FIG. 5b and d) are stable. In non-isothermal film-blowing, not only the bubble radius, but also the other state variables such as film thickness, bubble air pressure and freezeline height, all oscillate with time during draw resonance instability. The typical oscillation results of the bubble radius at the freezeline are shown in FIG. 5c, exhibiting an excellent agreement between the off-line film experimental data and the theoretical on-line simulation data.

The utility of these transient solutions for the film-blowing process is rather far-reaching in both the analysis and synthesis of the system. First, it enables us to confirm the same draw resonance criterion previously developed in fiber spinning and film casting based on the traveling times of kinematic waves, also applying to film-blowing. Second, the sensitivity analysis in assessing the effects of process conditions such as cooling, viscoelasticity of input polymers, and the air amount/pressure inside the bubble, on the behavior of the system can be easily performed with transient solutions as in other extensional deformation processes. Third, taking advantages of the two utilities mentioned above, we will be able to develop strategies for finding the optimal conditions for cooling, polymer viscoelasticity, air pressure/amount, freezeline height, etc., leading to enhanced productivity and film quality. Fourth, the transient solutions can also be applied in developing the apparatuses necessary for the optimization and stabilization of the process and can also prove useful in developing polymer materials.

### Advantageous Effects

As we have investigated through the practical example shown above, the present invention concerns a method for the dynamic scheming and yielding of transient solutions in the film-blowing process. By using the Newton's method and OCFE (Orthogonal Collocation on Finite Element), we were able to achieve transient solutions for the non-isothermal film blowing process. These solutions proved to be of great use when analyzing the nonlinear stability and nonlinear dynamics of the process. Also, through experiments, the numerical solutions that were obtained theoretically were verified to be useful. By taking into consideration the dynamics of the process that show nonlinear motion, the transient solutions may be applied in the optimum design of the process and in nonlinear control. We can also develop the apparatuses necessary for the optimization and stabilization of the film-blowing process, thereby realizing high-productivity and high-quality products. Therefore, the present invention is highly valuable in processes such as film, coating and flat display wherein the transformation of the film is important.

1. A method for yielding transient solutions for the film-blowing process by using a film-blowing process model characterized that the following governing equations in consideration of the viscoelasticity and cooling characteristics of the film are first solved; and then, through coordinate transformation, the free-end-point problem is changed into a fixed-end-point problem; and finally, by introducing Newton's method and OCFE (Orthogonal Collocation on Finite Elements), the transient solution for the film blowing process is obtained:
Equations:
$$\frac{\partial }{\partial t} ( rw \sqrt{1 + {( \frac{\partial r}{\partial z} )}^{2}} ) + \frac{\partial }{\partial z} ( rwv ) = 0 \\ Here , \\ t = \frac{\overline{t} \overline{{v}_{0}}}{\overline{{r}_{0}}} , z = \frac{\overline{z}}{\overline{{r}_{0}}} , r = \frac{\overline{r}}{\overline{{r}_{0}}} , v = \frac{\overline{v}}{\overline{{v}_{0}}} , w = \frac{\overline{w}}{\overline{{w}_{0}}} \qquad ( 1 )$$
Axial direction:
$$\frac{2 r w [ ( {τ}_{11} - {τ}_{22} ) ] + 2 r {σ}_{surf}}{\sqrt{1 + {( \partial r / \partial z )}^{2}}} + B ( {τ}_{F}^{2} - {r}^{2} ) - 2 {C}_{g τ} {\int }_{0}^{{z}_{2}} r w \sqrt{1 + {( \partial r / \partial z )}^{2}} ⅆ z - 2 {\int }_{0}^{{z}_{2}} τ {T}_{drug} ⅆ z = {T}_{z} \\ Here , \\ {T}_{z} = \frac{{\overline{T}}_{z}}{2 π {η}_{0} \overline{{w}_{0}} \overline{{v}_{0}}} , B = \frac{\overline{{r}_{0}^{2}} Δ P}{2 {η}_{0} \overline{{w}_{0}} \overline{{v}_{0}}} , Δ P = \frac{A}{{\int }_{0}^{{\overline{z}}_{L}} π \overline{{r}^{2}} ⅆ \overline{z}} - {P}_{a} , {τ}_{ij} = \frac{\overline{{τ}_{ij} {τ}_{0}}}{2 {η}_{0} \overline{{v}_{0}}} \\ {C}_{g τ} = \frac{ρ g \overline{{r}_{0}^{2}}}{2 {η}_{0} \overline{{v}_{0}}} , {T}_{drag} = \frac{\overline{{T}_{drag}} \overline{{r}_{0}^{2}}}{2 {η}_{0} \overline{{v}_{0}} \overline{{w}_{0}}} , {σ}_{surf} = \frac{\overline{{σ}_{surf}} \overline{{r}_{0}}}{2 {η}_{0} \overline{{v}_{0}} \overline{{w}_{0}}} \qquad ( 2 )$$
Circumferential direction:
$$B = ( \frac{[ - w ( {τ}_{11} - {τ}_{22} ) + 2 {σ}_{surf} ] ( {\partial }^{2} r / \partial {z}^{2} )}{{[ 1 + {( \partial r / \partial z )}^{2} ]}^{3 / 2}} + \frac{w ( {τ}_{33} - {τ}_{22} ) + 2 {σ}_{surf}}{r \sqrt{1 + {( \partial r / \partial z )}^{2}}} - {C}_{g τ} \frac{\partial r / \partial z}{\sqrt{1 + {( \partial r / \partial z )}^{2}}} ) \qquad ( 3 )$$
Constitutive Equation:
$$K τ + De [ \frac{\partial τ}{\partial t} + v \cdot ∇ τ - L \cdot τ - τ \cdot {L}^{T} ] = 2 \frac{De}{{De}_{0}} D \\ Here , \\ K = exp [ eDe tr τ ] , L = ∇ v - ξ D , 2 D = ( ∇ v + ∇ {v}^{2} ) , {De}_{0} = \frac{λ \overline{{v}_{0}}}{\overline{{τ}_{0}}} , \\ De = {De}_{0} exp [ k ( \frac{1}{θ} - 1 ) ] \qquad ( 4 )$$
Energy equation:
$$\frac{\partial θ}{\partial t} + \frac{1}{\sqrt{1 + {( \partial r / \partial z )}^{2}}} \frac{\partial θ}{\partial z} + \frac{U}{w} ( θ - {θ}_{c} ) + \frac{E}{w} ( {θ}^{4} - {θ}_{∞}^{4} ) = 0 \\ Here , \\ θ = \frac{\overline{θ}}{{θ}_{0}} , {θ}_{c} = \frac{{\overline{θ}}_{c}}{{θ}_{0}} , {θ}_{∞} = \frac{{\overline{θ}}_{∞}}{{θ}_{0}} , U = \frac{\overline{U} \overline{{r}_{0}}}{p {C}_{p} \overline{{w}_{0 }} \overline{{v}_{0}}} , \overline{U} = α ( \frac{{k}_{air}}{\overline{z}} ) {( \frac{{ρ}_{air} \overline{{v}_{0}} , \overline{z}}{{η}_{air}} )}^{β} , E = \frac{{ε}_{m} {σ}_{SB} \overline{{θ}_{0}^{4}} \overline{{r}_{0}}}{p {C}_{p} \overline{{w}_{0 }} \overline{{v}_{0}} {θ}_{0}} \qquad ( 5 )$$
Boundary conditions:
$$\begin{matrix}v = w = r = θ = 1 , \begin{matrix}τ = {τ}_{0} & at z = 0\end{matrix} & ( 6 a ) \\ \begin{matrix}\begin{matrix}\frac{\partial r}{\partial t} + \frac{\partial r}{\partial z} \frac{v}{\sqrt{1 + {( \partial r / \partial z )}^{2}}} = 0 , \\ \frac{v}{\sqrt{1 + {( \partial r / \partial z )}^{2}}} = {D}_{R} , θ = {θ}_{F}\end{matrix} & at z = {z}_{F}\end{matrix} & ( 6 b )\end{matrix}$$
wherein, r denotes the dimensionless bubble radius, w the dimensionless film thickness, v the dimensionless fluid velocity, t the dimensionless time, z the dimensionless distance coordinate, ΔP the air pressure difference between inside and outside the bubble, B the dimensionless pressure drop, A the air amount inside the bubble, Pₐ the atmospheric pressure, T_{z} the dimensionless axial tension, C_{gr} the gravity coefficient, T_{drag} the aerodynamic drag, σ_{surf} the surface tension, θ the dimensionless film temperature, τ the dimensionless stress tensor, D the dimensionless train rate tensor, ε and ξ the PTT model parameters, De the Deborah number, θ₀ the zero-shear viscosity, K the dimensionless activation energy, U the dimensionless heat transfer coefficient, E the dimensionless radiation coefficient, kₐᵢᵣ the thermal conductivity of cooling air, ρₐᵢᵣ the density of cooling air, ηₐᵢᵣ the viscosity of cooling air, v_{c} dimensionless cooling air velocity, α and β parameters of heat transfer coefficient relation, θ_{c} the dimensionless cooling-air temperature, θ_{∞} the dimensionless ambient temperature, εm the emissivity, σ_{SB} the Stefan-Boltzmamn constant, ρ the density, Cₚ the heat capacity, D_{R} the drawdown ratio;
the assumption was made that no deformation occurred in the film past the freezeline at the boundary conditions; overbars denote the dimensional variables; subscripts 0, F and L denote the die exit, the freezeline conditions and the nip roll conditions, respectively; and subscripts 1, 2 and 3 denote the flow direction, normal direction, and circumferential direction, respectively.

2. The method for yielding transient solutions for the film-blowing process by using a film-blowing process model according to claim 1, wherein the non-isothermal process model is a numerical scheme for yielding transient solutions for the film-blowing process, which has three multiplicities.

3. In a nonlinear stabilization analysis method of a process, the improvement comprising that it is an analysis method that utilizes the temporal pictures obtained from the numerical scheme in claim 1.

4. A method for the optimization of the process which is obtained by use of a sensitivity analysis of the relative effects affecting the stability of each process variable through a transient solution, which was calculated and yielded in the course of deduction of the transient solutions for the film-blowing process in claim 1.

5. An apparatus necessary for the optimization and stabilization of the process, which utilizes the numerical scheme stated in claim 1.
